(19) United States
(12) Patent Application Publication
(10) Pub. No.: US 2011/0138226 A1
(43) Pub. Date: Jun. 9, 2011

(54) SYSTEM AND METHOD FOR TESTING COMPUTING DEVICE

(75) Inventor: XIANG-YUN KONG, Shenzhen City (CN)

(73) Assignees: HONG FU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/719,821

(22) Filed: Mar. 8, 2010

(30) Foreign Application Priority Data
Dec. 4, 2009 (CN) 200910310939.7

(51) Int. Cl. G06F 11/26

(52) U.S. Cl. 714/27; 714/E11.159

(57) ABSTRACT

A system for testing a computing device includes a test device, a switch module connected between the test device and the computing device, and a display module connected to the test device for displaying a plurality of test parameters. The testing device is connected to the computing device via a USB connection. The test device has a power cycling test program and a display driving program. The test device sends trigger signals to turn the computing device on or off and receives signals from computing device via the USB connection, for detecting the occurrence of errors during testing. A method utilizing the system is also disclosed.

### BACKGROUND

1. Technical Field

The present disclosure relates to a power cycling test system and method for testing a computing device.

2. Description of Related Art

A computing device, such as a personal computer, a notebook computer, or a server, must be tested for performance prior to release to the market, including one or more power cycling tests.

However, in many cases the power cycling tests must be performed individually, representing considerable use of manpower and resources. Further, efficiency and accuracy of each power cycling test are not guaranteed.

What is needed, therefore, is a power cycling test system and method that can overcome the described limitations.

### BRIEF DESCRIPTION OF THE DRAWINGS

FIG. 1 is a schematic diagram of a power cycling test system for a computing device in accordance with an embodiment.

FIG. 2 is a schematic diagram illustrating a hardware configuration of the test device in FIG. 1.

FIGS. 3A-3B illustrate a flowchart of an embodiment of a power cycling test method for a computing device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

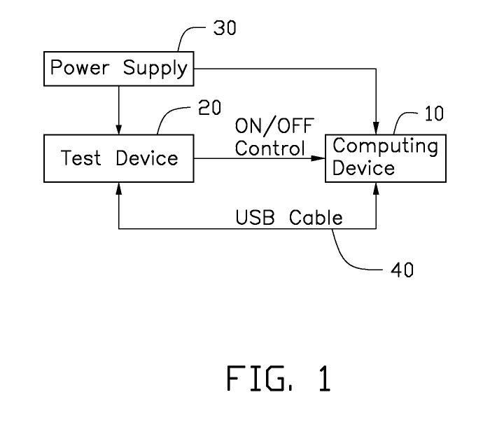

Referring to FIG. 1, a power cycling test system includes a computing device 10, a test device 20, a power supply 30 connected to the computing device 10 and the test device 20, and a Universal Serial Bus (USB) cable 40 connected between the computing device 10 and the test device 20. The test device 20 periodically turns the computing device 10 on and off during testing, and receives USB feedback from the computing device 10 indicating the occurrence of errors during testing.

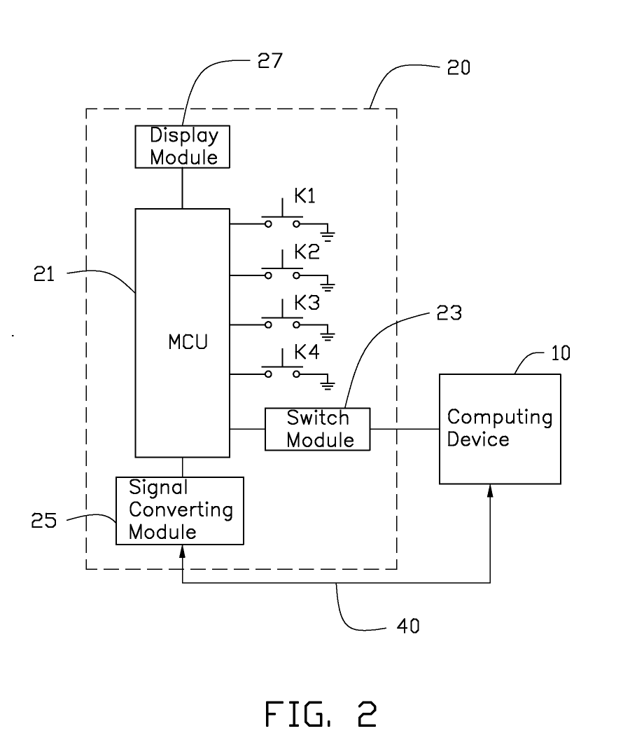

Referring to FIG. 2, the test device 20 includes a microcontroller unit (MCU) 21. In one embodiment, the MCU 21 is an ATMEGA16 chip including a 16 kb in-system programmable flash. The MCU 21 stores a power cycling test program, display driving program, and key-scan program therein. Each of the programs can constitute a module in the MCU 21. A switch module 23 (such as a relay) is connected between the MCU 21 and the computing device 10 for receiving trigger signals generated by the power cycling test program, thereby periodically turning the computing device 10 on and off according to the power cycling test program. A signal converting module 25 connects the computing device 10 and the MCU 21. An input terminal of the signal converting module 25 is connected to a USB interface of the computing device 10 for receiving the USB feedback from the computing device 10, and an output terminal of the signal converting module 25 is connected to the MCU 21. The signal converting module 25 is configured to convert the USB feedback to Transistor-Transistor Logic (TTL) signals compatible with the MCU 21. The test device 20 further includes a display module 27 connected to the MCU 21. Test parameters, such as cycle time and cycle number, may be displayed by the display module 27. The display driving program in the MCU 21 is capable of generating signals directing the display module 27 to show the test parameters.

A first key switch K1 is connected to the MCU 21 to start or stop the power cycling test after it is implemented. A second key switch K2 is connected to the MCU 21 for setting one of the test parameters after it has been triggered. For example, if the key switch K2 is actuated to set the cycle time, the cycle time can be shown on the display module 27. If the second key switch K2 is actuated again to set the cycle number, the cycle number can be shown on the display module 27 rather than the cycle time. A third key switch K3 is connected to the MCU 21 to increase a value of one of the test parameters. A fourth key switch K4 is connected to the MCU 21 to decrease a value of one of the test parameters. For example, if the cycle time is set and shown on the display module 27 as an initialization value of 500 seconds, the cycle time may be changed to 501 seconds after the third key switch K3 has been triggered once, or may be to 409 seconds after the fourth key switch K4 has been triggered once. The third key switch K3 or the fourth key switch K4 can be triggered repeatedly to increase or decrease the cycle time to execute different power cycling tests.

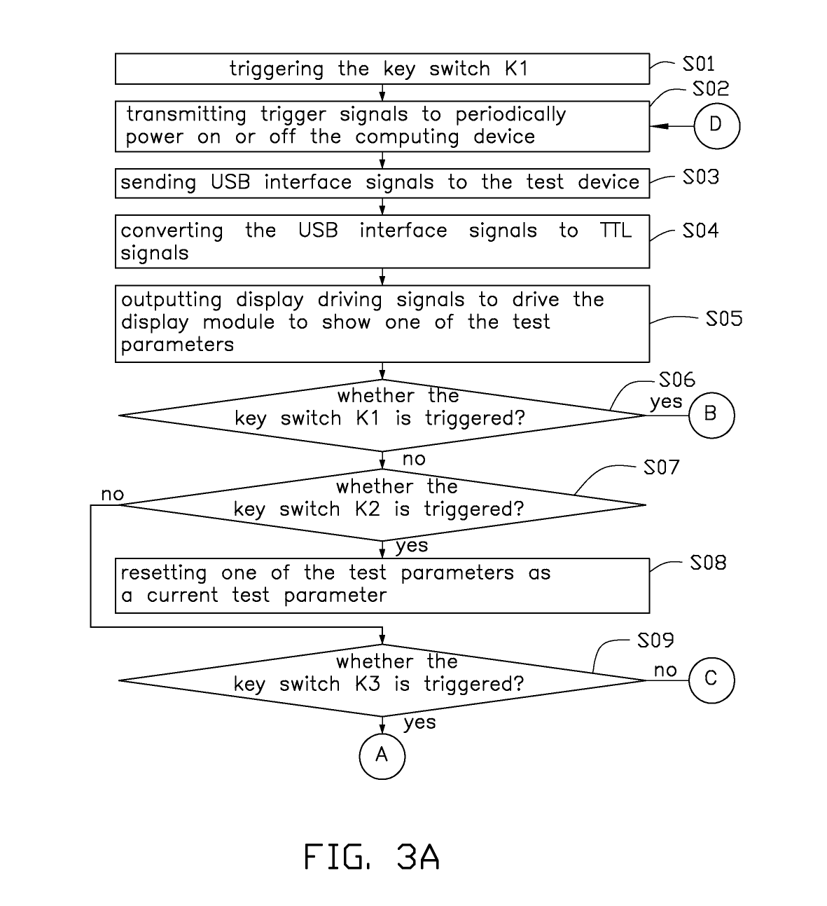

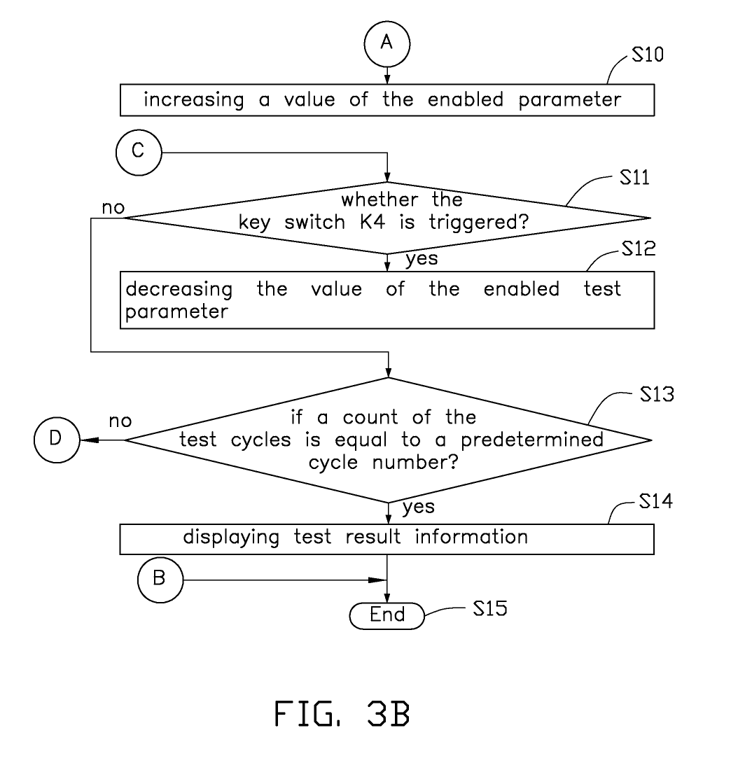

FIGS. 3A-3B show a testing method for a computing device, for example, the computing device 10 of FIG. 1, as follows.

In block S01, the key switch K1 has been triggered to implement the power cycling test program, display driving program, and the key-scan program in the MCU 21.

In block S02, the MCU 21 of the test device 20 transmits trigger signals generated by the power cycling test program to the switch module 23; and the switch module 23 turns the computing device 10 on or off according to the power cycling test program.

In block S03, the computing device 10 sends USB feedback to the test device 20 via the USB cable 40.

In block S04, the signal converting module 25 converts the USB feedback to TTL signals and transmits the TTL signals to the MCU 21. Thus, the MCU 21 is capable of monitoring the computing device 10 and detecting the occurrence of errors during the power cycling test. If errors occur, the power cycling test can be ended earlier than planned.

In block S05, the MCU 21 transmits display driving signals generated by the display driving program to the display module 27, and the display module 27 shows one of the test parameters currently enabled.

In block S06, the key-scan program determines whether the key switch K1 has been triggered. If the key switch K1 is triggered, go to block S15, and the power cycling test terminates; if the key switch K1 is not triggered, block S07 is implemented. In this block, as shown in FIGS. 3A-3B, a letter B is utilized to connect block S06 to block S15.

In block S07, the key-scan program determines whether the key switch K2 has been triggered.

In block S08, if the key switch K2 has been triggered, the MCU 21 resets one of the test parameters as a current test parameter which may be shown on the display module 27; for example, if the cycle time was enabled previously and shown on the display module 27, after the key switch K2 has been triggered once, the cycle number is enabled and shown on the display module 27 rather than the cycle time.

In block S09, if the key switch K2 has not been triggered, the key-scan program determines whether the key switch K3 has been triggered. If the key switch K3 is triggered, go to block S10; if not, go to block S11. In this block, as shown in FIGS. 3A-3B, a letter A is utilized to connect block S09 to block S10, and a letter C is utilized to connect block S09 to block S11.

In block S10, a value of the enabled parameter shown on the display module 27 is increased; for example, if the cycle number is enabled and shown as 500 on the display module 27, after the key switch K3 has been triggered, the cycle number is increased to 501.

In block S11, the key-scan program determines whether the key switch K4 has been triggered.

In block S12, if the key switch K4 has been triggered, the value of the enabled test parameter shown on the display module 27 is decreased; for example, if the cycle number is enabled and shown as 500 on the display module 27, after the key switch K4 has been triggered, the cycle number is decreased to 499.

In block S13, if the key switch K4 has not been triggered, the MCU 21 determines if a count of the test cycles is equal to a predetermined cycle number; if less than the predetermined cycle number, block S02 is repeated to continue transmitting trigger signals to test the computing device 10. In this block, as shown in FIGS. 3A-3B, a letter D is utilized to connect block S13 to block S02.

In block S14, if the count of the test cycles is equal to the predetermined cycle number, test result information is displayed and the power cycling test is ended.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A system for testing a computing device comprising:
a test device comprising a power cycling test module and a display driving module, the test device comprising a first interface, configured to transmit trigger signals generated by the power cycling test module, and a second interface, configured to transmit display driving signals generated by the display driving module, and a third interface, connected to the computing device for receiving signals from the computing device;
a switch module connected to the first interface and configured to receive the trigger signals from the first interface and to turn the computing device on or off;
a display module, connected to the second interface, configured to receive the display driving signals and to display a plurality of test parameters; and
a Universal Serial Bus (USB) cable connected between the third interface and a USB interface of the computing device;
wherein the test device is capable of receiving USB feedback from the computing device via the USB cable for detecting the occurrence of errors during testing.

2. The system of claim 1, wherein the test device further comprises a microcontroller unit, and the power cycling test module and the display driving module are installed in the microcontroller unit.

3. The system of claim 2, wherein the test device further comprises a signal converting module connected between the microcontroller unit and the computing device; the signal converting module is configured to convert USB feedback transmitted from the computing device to TTL signals.

4. The system of claim 2, wherein the test device further comprises a first key switch, connected to the microcontroller unit, that is capable of starting or stopping programs after it has been triggered.

5. The system of claim 4, wherein the test device further comprises a second key switch, connected to the microcontroller unit, that is capable of setting one test parameter after it has been triggered.

6. The system of claim 5, wherein the test device further comprises a third key switch, connected to the microcontroller unit, that is capable of increasing a value of the one test parameter after it has been triggered.

7. The system of claim 6, wherein the test device further comprises a fourth key switch, connected to the microcontroller unit, that is capable of decreasing the value of the one test parameter after it has been triggered.

8. The system of claim 7, wherein the plurality of test parameters comprises at least a cycle time or cycle number.

9. A method for testing a computing device, comprising:
connecting a test device to the computing device via a USB cable;
executing a power cycling test program and a display driving program in the test device;
applying on-off signals to the computing device;
transmitting display driving signals to a display module to show a plurality of test parameters; and
receiving signals generated from the computing device via the USB cable for detecting the occurrence of errors during testing.

10. The method of claim 9, wherein the applying on-off signals to the computing device comprises transmitting the on-off signals to a switch module, and switching the switch module on or off to turn the computing device on or off.

11. The method of claim 9, further comprising executing a key-scan program for detecting if a first key has been triggered to start or stop the test, if a second key has been triggered to set a one test parameter, if a third key has been triggered to increase a value of the one test parameter, and if a fourth key has been triggered to decrease the value of the one test parameter.

12. The method of claim 11, wherein the one test parameter is a cycle time.

13. The method of claim 12, further comprising increasing the cycle time if the third key has been triggered.

14. The method of claim 13, further comprising decreasing the cycle time if the fourth key has been triggered.

15. The method of claim 14, wherein the one test parameter is a cycle number.

16. The method of claim 15, further comprising increasing the cycle number if the third key has been triggered.

17. The method of claim 16, further comprising decreasing the cycle number if the fourth key has been triggered.

18. The method of claim 9, further comprising converting the signals generated from the computing device to TTL signals before receiving the signals.
